(19) United States
(12) Patent Application Publication
(10) Pub. No.: US 2015/0366221 A1
(43) Pub. Date: Dec. 24, 2015

(54) Hand-held automatic dispenser for flowable batter

(71) Applicant: Kristin Miley, New York, NY (US)

(72) Inventor: Kristin Miley, New York, NY (US)

(21) Appl. No.: 14/742,738

(22) Filed: Jun. 18, 2015

Related U.S. Application Data
(60) Provisional application No. 61/998,128, filed on Jun. 19, 2014.

(51) Int. Cl. A21C 5/00; B05C 17/005; B05C 17/01

(52) U.S. Cl. CPC A21C 5/006; B05C 17/0133; B05C 17/00596

(57) ABSTRACT

An apparatus adapted for dispensing flowable viscous batter has a housing, a barrel removably connected to the housing and a cap removably connected to the barrel. The housing contains a drive mechanism, a dual-position gearbox and a motor. The motor is in communication with the dual-position gearbox, which is in communication with the drive mechanism. The drive mechanism engages a threaded rod that is slidably disposed within the barrel. The threaded rod is attached to a piston that is non-rotatably positioned within the barrel. The drive mechanism actuates the threaded rod such that the piston is advanced or retracted in the barrel when power is supplied to the motor. The operating position of the gearbox determines whether the piston advances or retracts in the barrel when power is supplied to the motor. The cap includes a dispensing nozzle configured to regulate the flow of viscous batter from the barrel when the piston advances in the barrel. The cap also includes a piping spacer that facilitates consistent spacing and dispensing of batter on a baking surface.

### CROSS REFERENCE TO RELATED APPLICATIONS

I claim the benefit of the provisional patent with application No. 61/998,128 filed by Kristin Miley on Jun. 19, 2014 in respect of the invention titled “macaron batter dispenser”.

### BACKGROUND OF THE INVENTION

Methods of dispensing flowable viscous batter, such as the batter from which French macarons are made, are well known. Traditionally such batter is dispensed using commonplace collapsible conical plastic or textile bags (commonly known as pastry bags) that consist of a wide filling mouth and a tapered dispensing end into which a rigid conically shaped hollow dispensing nozzle may be inserted. In use, after a pastry bag has been filled with batter, the tapered dispensing end is positioned above a baking surface and the contents of the pastry bag are manually compressed to dispense the batter.

Although many people enjoy pastries such as French macarons that are made from flowable viscous batter, such pastries are not widely prepared by home bakers due to the perceived difficulty of making them. One such perceived difficulty is the manner in which batter is formed into pastries. Dispensing flowable viscous batter from pastry bags presents a number of challenges for non-expert home bakers. First, collapsible cones may be difficult to fill because the flexible textile or plastic material from which they are customarily made may fold over as batter is being poured into the wide mouth of the pastry bag, resulting in batter spillage and wastage. Second, before a pastry bag is filled with viscous flowable batter, the portion of the pastry bag in which a dispensing nozzle is positioned is folded upward to prevent batter from escaping the dispensing nozzle as the pastry bag is being filled. After the portion of the pastry bag housing the dispensing nozzle is unfolded from its initial filling position, batter will flow through the dispensing nozzle unless the bag is held with the nozzle positioned at an upward angle. Because the wide mouth end of the pastry bag lacks a planar surface upon which a filled pastry bag can be securely positioned when not in use, after the bag has been filled and the nozzle has been unfolded from the initial filling position, it is difficult and inconvenient to set a filled pastry bag down without causing spillage. Third, depending on the viscosity of the batter being dispensed, small variations in the pressure exerted on the pastry bag in dispensing its contents may cause batter to leak or flow from the open nozzle in an uncontrolled manner. Such leaking or uncontrolled batter flow may waste batter due to spillage and make it difficult to dispense batter in a precise and uniform manner. Fourth, if the pastry bag is overfilled or if the filling mouth is not adequately secured after filling, batter may escape from the wide end of the pastry bag during the dispensing process. Fifth, pastry bags do not incorporate a metering mechanism. It may be difficult for the user to consistently dispense equal amounts of batter for each pastry because dispensing pressure is exerted in a completely manual manner and therefore is inherently variable. Sixth, consistently dispensing batter on a baking surface in a manner that makes efficient use of space can require tedious preparation. If batter deposits are dispensed too closely together on the baking surface, two or more batter deposits may flow together, thereby producing aesthetically unappealing pastries. This problem may be addressed by manually tracing stencils on the baking surface onto which the batter is dispensed (traditionally parchment paper), which is a time-consuming process, each time pastries are prepared so as to facilitate dispensing of equal and equally spaced amounts of batter for each pastry. Seventh, variations in the angle at which batter is dispensed and the distance from the baking surface from which batter is dispensed can produce undesirable variations in the shape of each pastry, which ideally should be uniform in size and shape.

As an alternative to pastry bags, flowable viscous batter used to produce pastries such as French macarons may be dispensed using commonplace reusable squeezable cylindrical or bulb-shaped containers fitted with dispensing nozzles. Such squeezable containers address some, but not all, of the shortcomings of traditional pastry bags. Because the material from which such squeezable containers are made is more rigid than the flexible plastic resin film or textile material from which pastry bags are customarily made, squeezable containers may be easier to fill than pastry bags. Batter flow from such containers may also be easier to control because they only have one opening and can be positioned on a flat surface in a stable upright manner when they are filled or partially filled. A shortcoming of reusable squeezable containers is that because they are made from semi-rigid material, completely dispensing the contents of the container may require the user to exert considerable force, which may be challenging for some users. Furthermore, variations in the amount of force that needs to be exerted to dispense each incremental quantity of batter as the contents of the squeezable container decrease may make it difficult to consistently dispense equal amounts of batter for each pastry. A related point is that this type of device lacks a metering mechanism for consistently dispensing equal amounts of batter that is suitable for flowable viscous batter. The user must also control the angle at which batter is dispensed onto the baking surface and the distance from the baking surface at which the batter is dispensed. Although this type of product may be less messy than a collapsible cone, for the reasons described above, it does not offer advantages in the area of dispensing uniformly sized and shaped amounts of batter relative to a traditional pastry bag.

Another commonplace product that attempts to address certain of the shortcomings of the traditional approach to making French macarons is a silicone baking mat into which multiple raised circular ridges designed to shape batter into the desired dimensions have been molded. This type of product seeks to mitigate issues relating to inconsistency in the amount and shape of batter dispensed by providing a visual batter dispensing guide that is similar to the manual stenciling approach described above, and also by shaping batter into perfectly uniform circles. Shortcomings of this product include that multiple baking mats are necessary to conveniently produce a large batch of pastries, that the texture of the bottom surface of a pastry baked on a silicone baking surface may differ from the texture of the bottom surface of a French macaron baked on traditional parchment paper, that pastries may stick to the silicone baking sheet, that the mats are inconvenient to clean, that the mats only allow the user to produce pastries of one size and that the ruffled edges (commonly known as “feet”) of French macarons baked on silicone baking mats with circular ridges may not be aesthetically pleasing. Furthermore, silicone baking mats are positioned on metal baking sheets during the baking process and may warp when they are exposed to heat in an oven, which can produce undesirable irregularities in pastry shape. Although this type of product may produce more uniformly shaped pastries than dispensing batter with a collapsible cone or squeezable bulb, as described above, this approach also presents various shortcomings.

Various other manually operated devices designed to dispense flowable batter of low viscosity, dough and other food stuffs are well-known, however none of these products are specifically adapted for or are traditionally used to produce pastries such as French macarons that require dispensing of small quantities of flowable viscous batter in a precise and uniform manner.

U.S. Pat. No. 6,367,661 issued to Valente is an example of a manually operated hand-held batter dispenser intended to dispense cupcake, pancake and similarly flowable pastry batters. This type of device consists of a housing into which batter is placed and a spring handle that controls a slidable plate that blocks an interior spout hole when the spring handle is in the closed position. Depressing the spring handle retracts the plate and allows the batter in the housing to flow through the spout hole. While this type of device is suitable for use with a flowable batter of thin viscosity, it is less suitable for a batter of thicker viscosity, such as that used in preparation of French macarons, because a thicker batter may not flow with the desired velocity solely through the effect of gravity when the spring handle is depressed. Furthermore, this device is generally not conducive to maintaining precise control over the amount of batter dispensed and the manner in which it is dispensed.

Hand-held presses or s that extrude dough, such as cookie dough, are commonplace. The specific objective of many such devices is to extrude dough in a decorative shape spritz cookies). Manual presses typically include a barrel that receives dough and a lever or handle that engages teeth disposed on a rod that is attached to a piston configured to advance in the barrel. When the lever or handle is activated, the rod advances in the barrel and extrudes food material contained in the barrel through an aperture at the lower end of the barrel. Such devices may include interchangeable disc-like dies with aperturized designs that determine the shape of the dough that is dispensed. Although certain elements of manual dough presses are suited for production of French macarons, commonplace manual presses suffer from significant shortcomings as it relates to this application. First, they lack a mechanism to effectively regulate the flow of a flowable viscous batter. Second, they lack components that stabilize or position the press during the extrusion process to ensure complete uniformity of the angle and positioning of batter as it is dispensed. Third, manual presses may be difficult for some users to operate due to the amount of force required to activate the lever or handle when the barrel is filled with a food substance. Furthermore, because the amount of force required to operate the press is proportional to the quantity of dough contained in the barrel, the feasible size of a manual press's barrel is delimited by the amount of force the average user can exert.

Battery-operated presses or guns that extrude dough are also known in the art. Like manual dough presses, battery-operated dough presses are designed to extrude dough, often in decorative shapes, but their operation requires exertion of less force than manual presses. Like the manual presses described above, however, battery-operated dough presses are not adapted to or suitable for use with the viscous flowable batter used to produce pastries such as French macarons because such presses lack components that stabilize and position the press to ensure uniformity of the angle and positioning of batter as it is dispensed and because such devices lack means to effectively regulate the flow of a viscous batter.

is therefore an object of the invention to provide a hand-held batter dispenser that alleviates or eliminates the aforementioned problems as they relates to the home user's production of pastries made from flowable viscous batter, such as French macarons. It is a specific object of the invention to provide a batter dispenser that is easy to use and minimizes batter spillage and waste. It is also the object of the invention to reduce variability in the dispensing process and to allow the user to easily produce uniformly sized and shaped pastries. It is another object of the invention to serve as a guide for efficient and consistent spacing of pastry batter on the baking surface. It is also an object of the invention to allow the user to adjust the size of pastry produced as desired. Furthermore, it is another object of the invention to provide a device that is compact and easy to store.

### BRIEF SUMMARY OF THE INVENTION

The present invention relates to an apparatus for dispensing a flowable viscous food substance such as pastry batter. The apparatus is formed from a housing, a barrel removably connected to the housing, a piston that is slidably positioned within the barrel and a piston rod with external threads over a portion of its length that is connected to the piston. The interior wall of the barrel contains vertical threads that correspond with notches in the piston. This configuration prevents the piston from rotating within the barrel.

The housing includes a motor powered by internal batteries. Power is supplied from the internal batteries to the motor through a simple momentary activation button. Depressing the button supplies electricity to the motor, thereby turning it on, and releasing the button disrupts power to the motor, thereby turning it off The motor is in communication with a two-position gearbox that controls the direction in which the piston rod and piston move when the motor is activated. The position of the gearbox is controlled by means of a rotatable collar that encircles the lower portion of the housing. A protruding key disposed on the front portion of the rotatable collar is provided to allow the user to shift the gearbox into one of the two operating positions.

In gearbox operating position 1, a series of gears are configured to provide high torque (and slower) downward movement of the piston for dispensing of barrel contents. In gearbox operating position 2, a series of gears are configured to provide high-speed (and lower torque) upward movement of the piston for retracting. Through this arrangement, the gearbox provides for two different speeds and two different directions for rod and piston travel. This configuration facilitates efficient and convenient operation given the need for slow downward dispensing to allow for precise and measured control of batter flow and fast piston retracting for refilling of barrel contents.

The gearbox is in communication with a drive mechanism that directly engages the piston rod. The drive mechanism assembly includes a gear shaft, the piston rod, an upper compression spring and a lower compression spring. The gear shaft has a through-bore for slidably receiving the piston rod. A portion of the through-bore is threaded and is provided for rotating the piston rod. When the threaded portion of the piston rod passes through the threaded portion of the gear shaft, the external threads of the piston rod are engaged by the internal threads of the gear shaft. A plurality of vertical threads that mate with the teeth of the gearbox gears are disposed on the outer surface of the gear shaft. When the motor activates the gears of the gearbox, the teeth of one of the gearbox gears engage the vertical ribs of the gear shaft. The resultant rotation of the gear shaft engages the piston rod. The thread and mating notch configuration of the piston and the barrel prevent the piston rod from rotating in the barrel when it is actuated by the gear shaft. Through this configuration, the rotational movement of the gearbox and gear shaft are translated into linear movement of the piston rod and piston.

Portions of the piston rod are unthreaded to prevent overtravel. When the piston rod is fully extended or fully retracted, the threaded portion of the rod may travel partially out of the threaded portion of the gear shaft. Compression springs positioned above and below the gear shaft urge the gear shaft towards consistent engagement with the threads of the piston rod when the direction of travel of the fully extended or fully retracted piston rod is reversed by changing the position of the gearbox.

The present invention includes a barrel cap removably attached to the barrel. The barrel cap serves to locate a flow-regulating dispensing nozzle adapted to dispense viscous batter in a controlled manner. The barrel cap also includes a piping spacer that stabilizes the apparatus during operation, provides means for situating the dispensing nozzle in the preferred position relative to the baking surface when the press is in operation and provides means for efficiently dispensing pastries on a baking surface. The present invention additionally includes a stand upon which the press can be stably positioned and stored in an upright position when not in use. A cap for the dispensing nozzle that prevents the flow of batter when the press is filled but not in use is also provided.

### BRIEF DESCRIPTION OF DRAWINGS

Further novel aspects of the invention and the advantages of these aspects will be understood from the detailed description of the preferred embodiments of the present invention with reference to the accompanying drawings, in which:

FIG. 1 is a front perspective view of an embodiment of the automatic batter press of the present invention;

FIG. 2 is a back perspective view of an embodiment of the automatic batter press of the present invention;

FIG. 3 is a side elevational view of the assembled barrel, barrel cap and stand;

FIG. 4 is an exploded perspective view of the barrel, barrel cap, stand and nozzle cap;

FIG. 5 is an exploded perspective view of the piston and rod;

FIG. 6 is an exploded perspective of the gear shaft assembly;

FIG. 7 is an enlarged sectional view of the assembled gear shaft assembly illustrated in FIG. 6;

FIG. 8 is a cross sectional view of the automatic batter press illustrated in FIG. 1 taken along line 8-8;

FIG. 9 is a cross sectional view of the automatic batter press illustrated in FIG. 1 taken along line 9-9;

FIG. 10 is a bottom perspective view of the interior compartment of the housing;

FIG. 11 is an exploded perspective view of the gearbox assembly;

FIG. 12 is a perspective view of the gearbox assembly of FIG. 11. in operating position 1;

FIG. 13 is a perspective view of the gearbox assembly of FIG. 11 in operating position 2;

FIG. 14 is a bottom perspective view of the rotatable collar;

FIG. 15 is a top view of the rotatable collar.

### DETAILED DESCRIPTION OF THE INVENTION

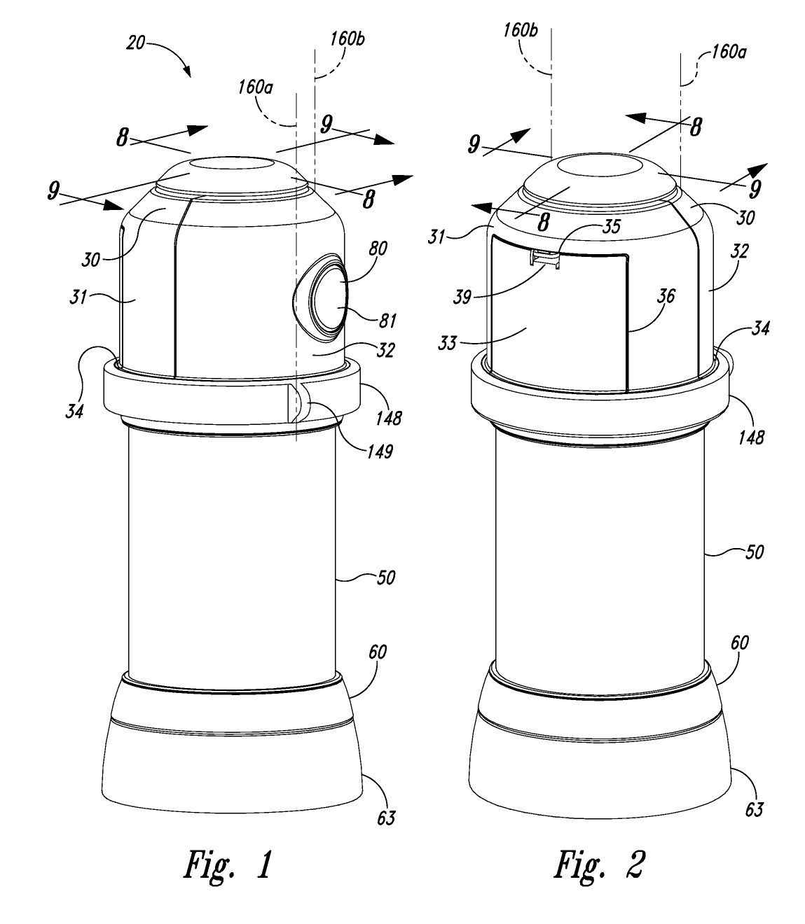

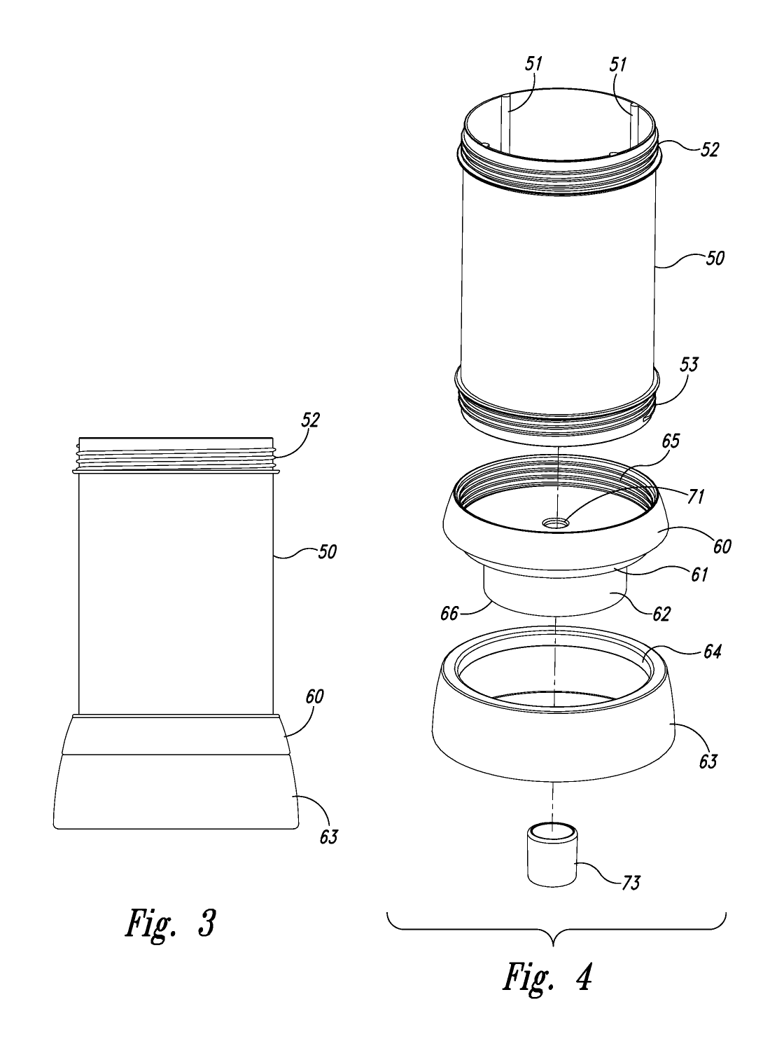

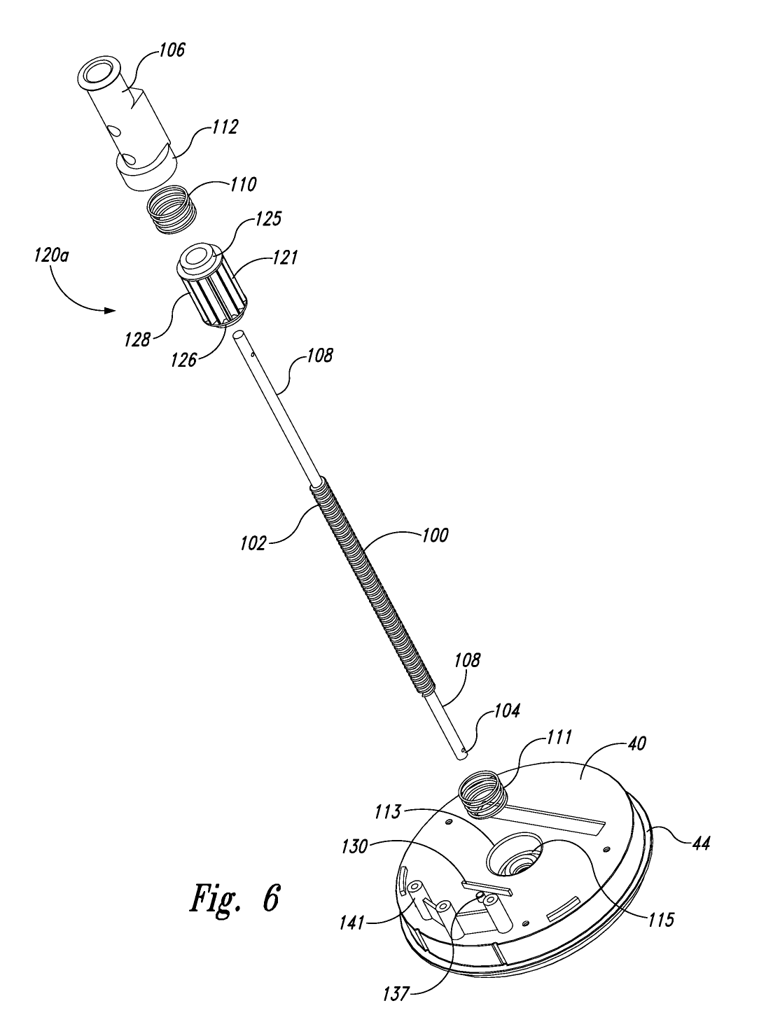

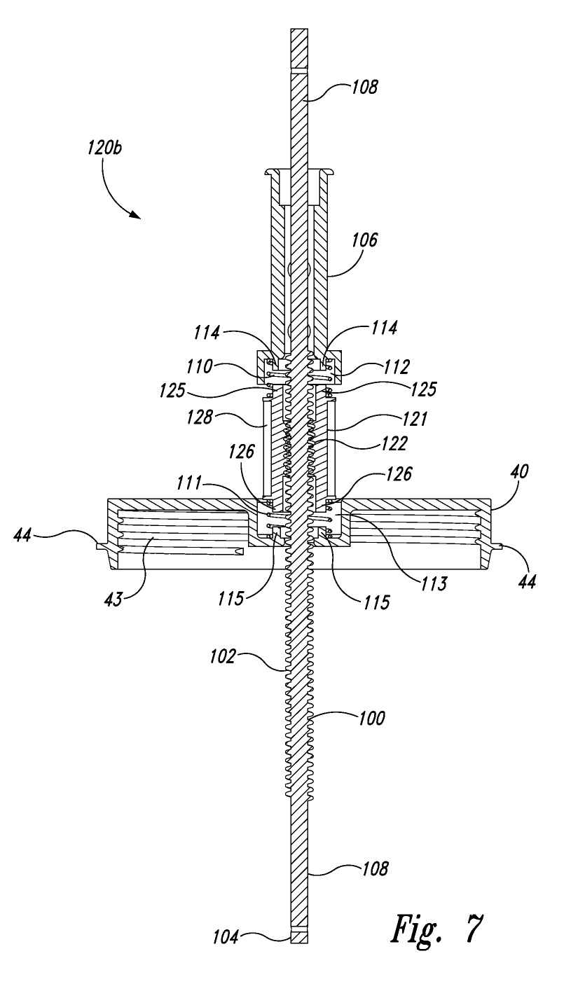

An embodiment of the automatic batter press of the present invention 20 is illustrated in general in FIG. 1. Automatic batter press 20 includes a housing 30 and a barrel 50. Barrel 50 is removably attached to housing 30. Housing 30 has a front portion 32, a back portion 31 and a housing floor 40 (shown in FIG. 6 and FIG. 7). Housing floor 40 is circular in shape and includes a downwardly protruding annular wall upon which annular threads 43 are disposed Annular threads 43 engage either identical external annular threads 52 or external threads 53 (shown in FIG. 3 and FIG. 4) that are respectively located on one end of barrel 50. This configuration allows barrel 50 to easily attach to and disengage from housing floor.

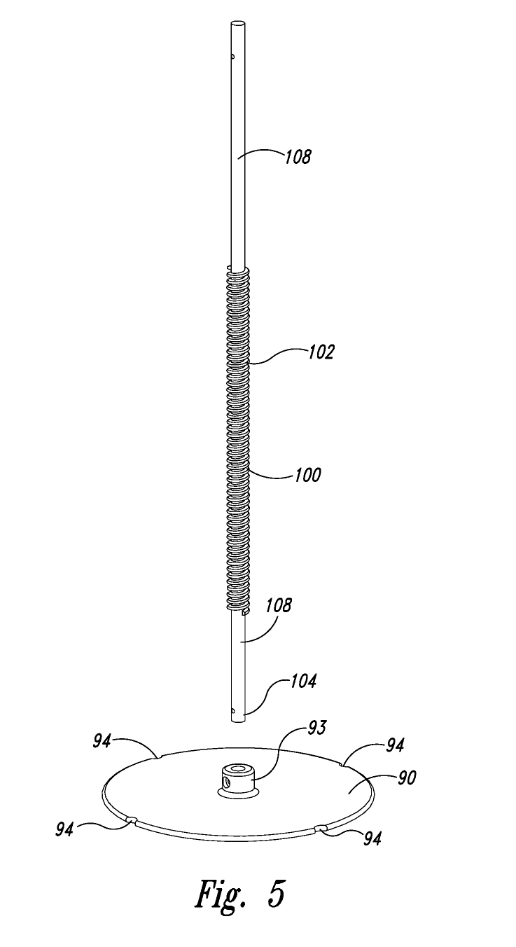

Barrel 50, illustrated in FIG. 3 and FIG. 4, has a circular cross section and is preferably formed from a clear plastic material. Barrel 50 is sized to allow a circular piston 90 (FIG. 5) to slide along its length. Barrel 50 includes vertical threads 51 disposed on its interior wall (FIG. 4). As shown in FIG. 5, a plurality of notches 94 that mate with vertical threads 51 of barrel 50 (FIG. 4) are disposed on piston 90. This thread and mating notch configuration provides means for preventing piston 90 from rotating within barrel 50 when the automatic batter press of the present invention is operated. Variations to this embodiment of means for preventing rotation of piston 90 within barrel 50 during operation of the automatic batter press may be implemented without departing from the scope of the invention defined in the appended claims.

As shown in FIG. 4, the automatic batter press of the present invention includes a barrel cap 60 that is removably attachable to barrel 50. Barrel cap 60 includes an upwardly protruding annular wall within which annular threads 65 are disposed. Barrel cap annular threads 65 engage either external annular threads 52 or external annular threads 53 of barrel 50, which are interchangeable. This threaded connection enables barrel 50 and barrel cap 60 to be easily removed from each other for cleaning or for refilling of the automatic batter press. A stand 63 (shown in FIG. 4) that is preferably made from rubber is provided for storing the invention upright on a planar surface when it is not in use. A protruding annular flange 61 on the lower portion of barrel cap 60 is sized to fit within an annular shoulder 64 that is disposed within the upper interior portion of stand 63. An interference fit between annular shoulder 64 of stand 63 and annular flange 61 of barrel cap 60 ensures that stand 63 remains securely attached to barrel cap 60 during storage.

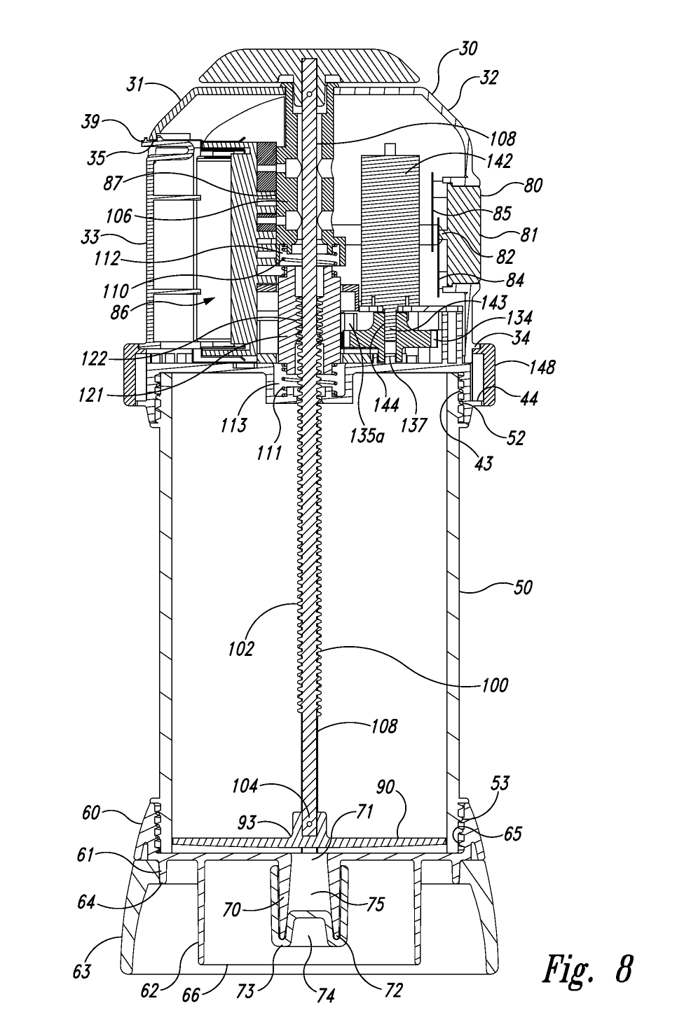

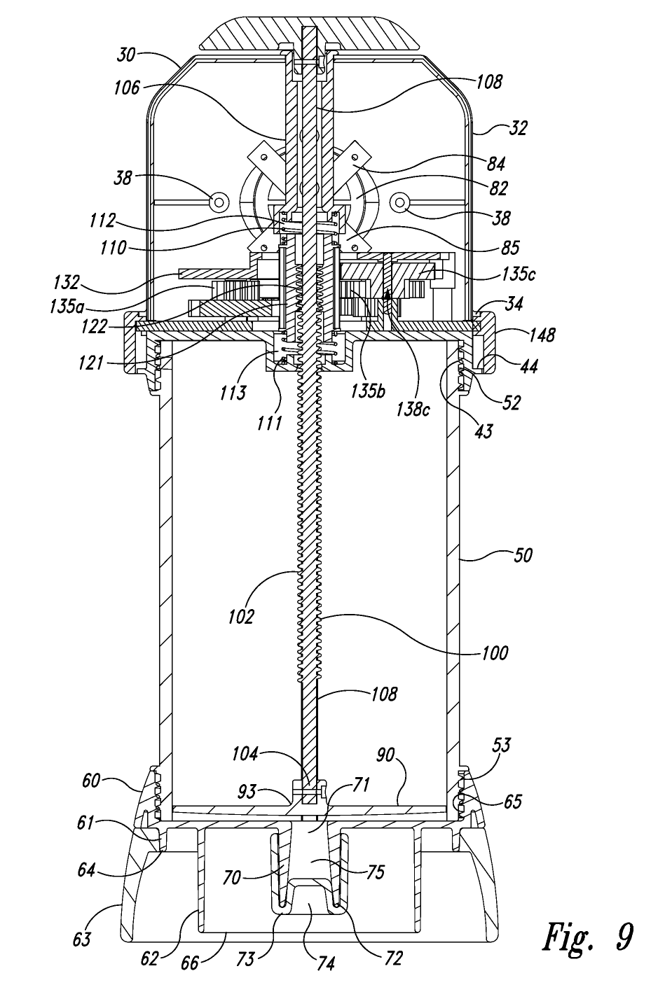

Barrel cap 60 includes an upper aperture 71 (FIG. 4) through which batter escapes barrel 50 when the automatic batter dispenser of the present invention is operated. As shown in FIG. 8 and FIG. 9, aperture 71 leads to a hollow passage 75 disposed within a dispensing nozzle 70. Dispensing nozzle 70 includes a lower aperture 72 through which batter escapes hollow passage 75 when the automatic batter dispenser of the present invention is operated. The interior diameter of hollow passage 75 increases in size over its length from the diameter of upper aperture 71 to the diameter of lower aperture 72. The increase in diameter between upper aperture 71 and lower aperture 72 prevents the velocity of batter flow from increasing as batter travels downward through hollow passage 75. The diameter of upper aperture 71 determines the velocity at which batter escapes barrel 50 when the automatic batter press of the present invention is operated. The preferred diameter of upper aperture 71 is determined by the maximum expected gravitational pressure exerted by the contents of barrel 50 when it is fully filled. The maximum expected gravitational pressure exerted by the contents of fully filled barrel 50 is proportional to the dimensions of barrel 50, and therefore may vary depending on the dimensions of the specific embodiment of the automatic batter press of the present invention. The preferred diameter of upper aperture 71 is also determined by the desired velocity of batter flow, and may vary depending on the viscosity of the particular type of batter being dispensed. Lower aperture 72 regulates the shape of batter as it escapes hollow passage 75. The diameter of lower aperture 72 in the embodiment of the present invention shown in FIG. 8 and FIG. 9 is sized to approximately one third of the desired diameter of the baked pastry shell. The diameter of upper aperture 71 of the embodiment of the present invention shown in FIGS. 8 and 9 is sized to approximately one half of the diameter of lower aperture 72. Variations in the absolute and relative dimensions of the diameters of upper aperture 71 and lower aperture 72 may be implemented without departing from the scope of the invention defined in the appended claims.

A nozzle cap 73 (FIG. 3) that is preferably made from silicone and that fits onto dispensing nozzle 70 is provided to prevent the flow of batter from barrel 50 when the automatic batter press of the present invention contains batter but is not in operation. As shown in FIG. 8 and FIG. 9, nozzle cap 73 includes an indented tip 74 that fits into hollow passage 75 of dispensing nozzle 70. When nozzle cap 73 is placed onto dispensing nozzle 70, if hollow passage 75 contains batter, indented tip 74 displaces a portion of any batter present in hollow passage 75, which forces batter through upper aperture 71 and into barrel 50. After nozzle cap 73 is removed, batter must travel through the portion of hollow passage 75 from which batter has been displaced to lower aperture 72 before escaping from dispensing nozzle 70. The time it takes the batter to travel this distance allows the user to reposition the apparatus of the present invention for dispensing in the desired position before batter escapes the lower aperture, thereby avoiding batter leakage.

Barrel cap 60, shown in FIG. 4, includes a piping spacer 62 that stabilizes the automatic batter press of the present invention during operation. As shown in FIG. 8 and FIG. 9, piping spacer 62 also provides means for situating dispensing nozzle 70 in the preferred position relative to the baking surface when the press is in operation. Piping spacer 62 comprises an annular wall that protrudes downward from the base of barrel cap 60. Dispensing nozzle 70 is disposed within the enclosure formed by the annular wall of piping spacer 62. In operation, the automatic batter press of the present invention is positioned on the bottom edge 66 of piping spacer 62, which provides a means for stabilizing the press on the baking surface as batter is being dispensed. Lower aperture 72 of dispensing nozzle 70 is recessed from bottom edge 66 of piping spacer 62 such that batter can flow freely from lower aperture 72 onto the baking surface when automatic batter press 20 is activated.

Piping spacer 62 also provides means for efficiently dispensing pastries on a baking surface. More specifically, piping spacer 62 comprises a guide for spacing batter deposits sufficiently far apart from each other that batter deposits will not run together, but close enough to each other that baking surface area is not wasted on unnecessarily wide margins between batter deposits. In operation of the automatic batter press of the present invention, as batter is deposited, the user positions the outer edge of piping spacer 62 adjacent to a quantity of batter that has been dispensed, stabilizes lower edge 66 of piping spacer 62 on the baking surface and dispenses an additional quantity of batter on the baking surface. Repetition of this process as the contents of barrel 50 are dispensed ensures that quantities of batter are dispensed at consistent intervals on the baking surface. In this way, piping spacer 62 provides an alternative to manually drawing templates for dispensing batter on a baking surface. The preferred size of piping spacer 62 will vary depending on the desired size of the pastry to be produced.

As illustrated in FIG. 5, piston 90 is attached to a piston rod 102. Helical threads 100 are disposed on a substantial portion of the middle section of piston rod 102. In the embodiment of the automatic batter press shown in FIG. 5, piston rod 102 is connected to piston 90 by a socket arrangement. More specifically, piston 90 includes an upwardly protruding socket 93 that receives the lower end 104 of piston rod 102. Alternatively, piston 90 and center rod 102 may be may be constructed as a single piece or joined by means other than described above without departing from the scope of the invention defined in the appended claims.

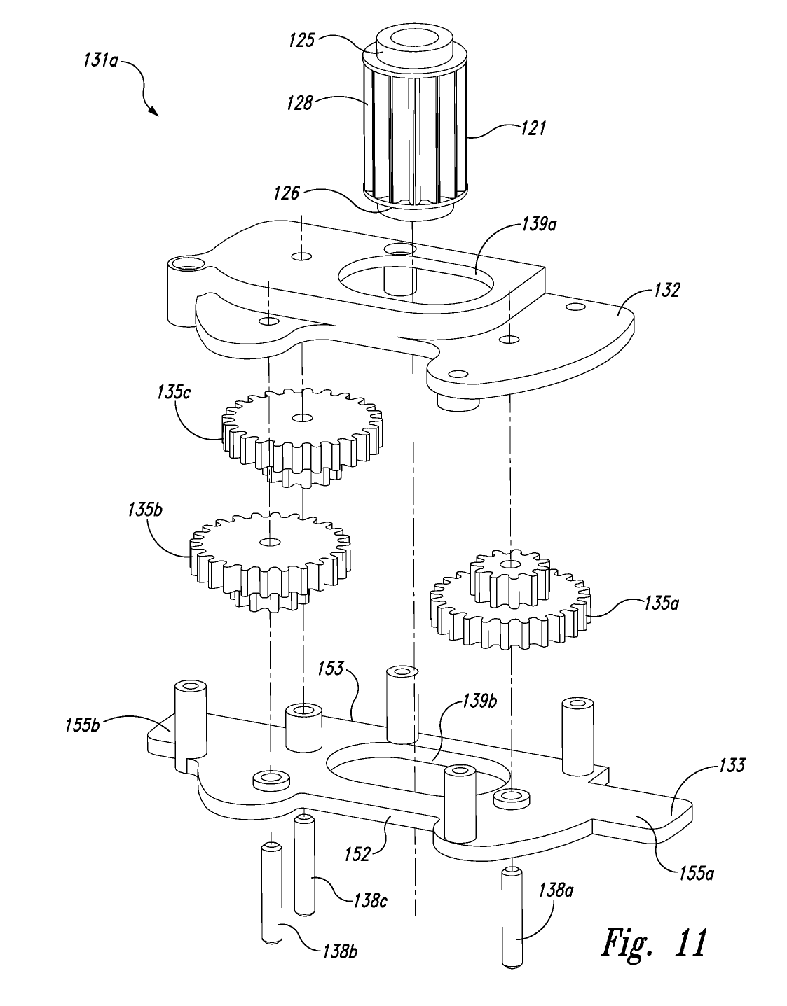

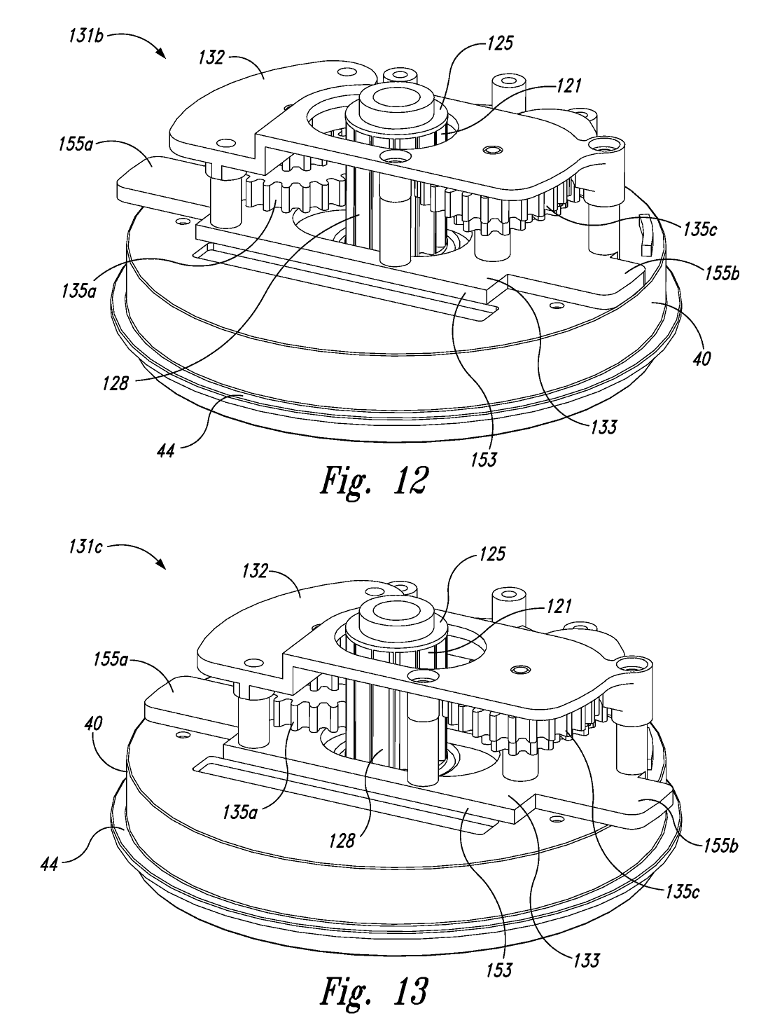

FIG. 8 and FIG. 9 are cross sectional views respectively taken across lines 8-8 and 9-9 of FIG. 1 that illustrate the interior configuration of an embodiment of the automatic batter press of the present invention. Housing 30 contains an interior framework that includes a battery compartment 86 in which batteries are situated (FIG. 8). Housing 30 also includes a drive shaft assembly 120 (shown in FIG. 6 and FIG. 7) that actuates center rod 102 and advances piston 90 when the automatic batter press of the present invention is activated. Housing 30 additionally contains a gearbox assembly 131 (shown in FIG. 11). A motor 142 (shown in FIG. 8) that is in communication with the batteries provides means for activating a drive gear 134 (FIG. 8), which in turn engages the components of a gearbox assembly 131 (FIG. 11, FIG. 12 and FIG. 13) when the automatic batter press of the present invention is activated.

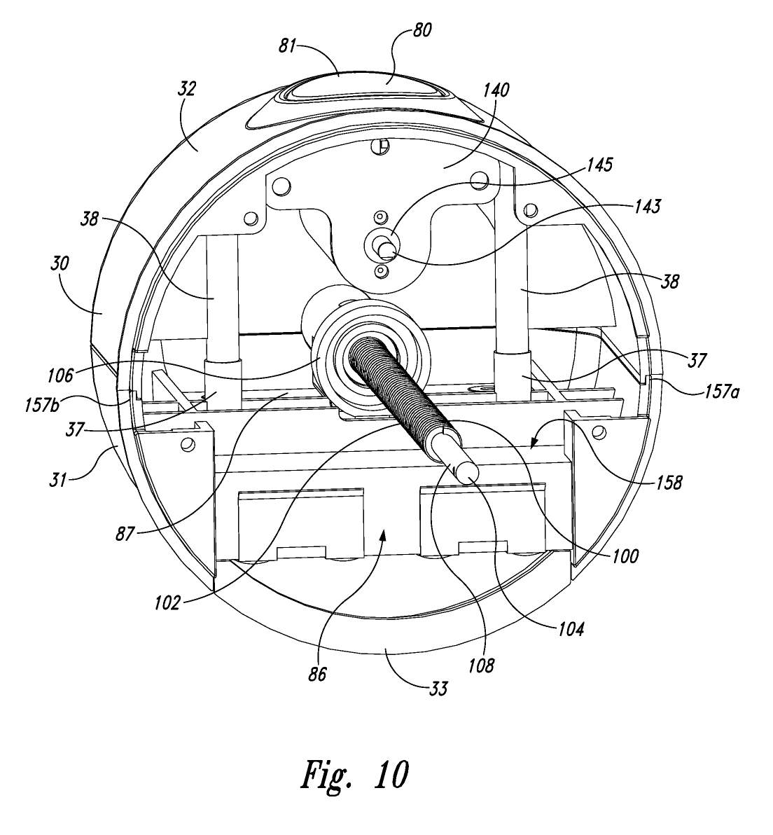

As illustrated in FIG. 1, FIG. 8 and FIG. 10, the automatic batter press of the present invention also includes an activation button 80. Activation button 80 is preferably disposed within front portion 32 of housing 30 such that a portion of activation button 80 extends outwardly from the surface of front portion 32 of housing 30. Activation button 80 includes a front surface 81 and as illustrated in FIG. 8, a back surface 82.

As shown in FIG. 8, battery compartment 86 houses batteries that provide power to operate motor 142 when front surface 81 of activation button 80 is depressed. An upper contact strip 84 and a lower contact strip 85, both of which are preferably made of a flexible metal material capable of conducting electricity, provide means for regulating the flow of electricity between the batteries and motor 142. As illustrated in the embodiment of the automatic batter press shown in FIG. 9, contact strip 84 and contact strip 85 are fastened to the interior wall of housing 30 in a perpendicular configuration in which the center portions of both contact strips are aligned. As shown in FIG. 8, contact strip 84 is positioned above contact strip 85 such that the two contact strips are not in contact when the automatic batter press of the present invention is not in operation. In operation, depression of front surface 81 of activation button 80 causes back of activation button 82 to exert pressure on upper contact strip 84. When upper contact strip 84 is pressured by force exerted by back of activation button 82, upper contact strip 84 flexes and comes into contact with lower contact strip 85. Upper contact strip 84 and lower contact strip 85 are in communication with the batteries and also with motor 142. Therefore, when activation button 80 is depressed, power from the batteries is transmitted to motor 142 and the motor is activated.

The automatic batter press of the present invention includes a battery compartment door 33 (shown in FIG. 1), which is preferably located in back of housing 31 for convenient access to the batteries. Battery compartment door 33 fits into a recess 36 in back of the housing 31. As shown in FIG. 2 and FIG. 8, battery compartment door 33 includes a depressible release latch 39 that mates with a release latch notch 35 located at the top of recess 36 in back of housing 31. Depression of release latch 39 causes battery compartment door 33 to unlatch from latch notch 35 and to disengage from the apparatus thereby allowing the user to access the batteries in battery compartment 86. To return battery door 33 to the apparatus, battery door 33 is aligned with recess 36 in back of housing 31 and release latch 39 is snapped back into battery door latch notch 35.

As shown in FIGS. 6 and 7, drive shaft assembly 120 includes a piston rod guide 106, an upper compression spring 110, a gear shaft 121, piston rod 102, a lower compression spring 111 and housing floor 40.

Gear shaft 121 has a through-bore for slidably receiving piston rod 102. A threaded portion 122 of the through-bore is provided for rotating piston rod 102. Internal annular threads disposed within threaded portion 122 of the through-bore of gear shaft 121 are sized to engage the external annular threads of threaded portion 100 of piston rod 102. When threaded portion 100 of piston rod 102 comes into contact with threaded portion 122 of gear shaft 121, the external threads of threaded portion 100 of piston rod 102 are engaged by the internal threads of threaded portion 122 of gear shaft 121. Segments 108 on the upper and lower portions of piston rod 102 are unthreaded to prevent overtravel of the rod during operation of the apparatus of the present invention. The length of threaded portion 100 of piston rod 102 is calibrated to partially disengage from threaded portion 122 of gear shaft 121 when piston 90 is either fully extended or fully retracted within barrel 50. Upper compression spring 110 and lower compression spring 111 provide additional means for urging threaded portion 122 of gear shaft 121 towards consistent engagement with threaded portion 100 of piston rod 102 when the direction of travel of fully extended or fully retracted piston rod 102 is reversed by changing the position of gearbox assembly 131.

Piston rod guide 106 is fastened to the back of the battery compartment 87 (shown in FIG. 10). Together with housing floor 40, piston rod guide 106 comprises means for holding gear shaft assembly 121 in place. As shown in FIG. 7, the lower portion of piston rod guide 106 contains an upper spring compartment 112 sized to contain upper compression spring 110. An annular shoulder 114 disposed within upper spring compartment 112 is provided to hold the top end of upper compression spring 110 in place within upper spring compartment 112. The upper portion of gear shaft 121 includes a shoulder 125 upon which the lower end of upper compression spring 110 is positioned. The lower portion of gear shaft 121 includes an annular shoulder 126 upon which the top end of lower compression spring 111 is positioned. Housing floor 40 contains a lower spring compartment 113 sized to house lower compression spring 111. An annular shoulder 115 is disposed within lower spring compartment 113 and provides means for holding lower compression spring 111 in place. Although compression springs are used in the preferred embodiment of the automatic batter press of the present invention, other types of springs, such as rubber cylinders, may alternatively be used.

Together with gear shaft assembly 121, gearbox assembly 131 (an exploded view of which is shown at 131a in FIG. 1 provides means for converting the rotational movement of motor 142 into the linear movement of piston rod 102. Gearbox assembly 131 can be operated in two different positions. In operating position 1 (shown at 131b ire FIG. 12) a series of reduction gears directs the piston downward with high torque and at a slow speed to maintain control over batter dispensing and to accommodate the resistance of the batter. In operating position 2 (shown at 131c in FIG. 13) a reduction gear provides high-speed and lower-torque upward movement to quickly retract the (piston for filling or refilling of barrel 50.

As illustrated in FIG. 11, gearbox assembly 131 includes reduction gears 135a, 135b and 135c that are assembled between a gearbox top 132 and a gearbox bottom 133 by means of pins 138a, 138b and 138c. A plurality of teeth are disposed on the outer edges of each of reduction gears 135a, 135b and 135c. The degree of speed reduction produced by reduction gears 135a, 135b and 135c is determined by the ratio of the diameters of these gears, or more specifically, the number of teeth that are engaged in translating the movement of motor 142 to the movement of gear shaft 121. In the preferred embodiment of the apparatus of the present invention, gearbox assembly 131 is configured with two reduction gears (135b and 135c) in operating position 1 and one reduction gear in operating position 2 (135a), however, gearbox assembly 131 may be designed with gears of varying size and number without departing from the scope of the invention defined in the appended claims.

As shown in FIG. 8, the output shaft 143 of motor 142 is inserted slot 144 in the top portion of press drive gear 134. Slot 144 has been configured for an interference fit with output shaft 143 such that when activation button 80 is depressed, the rotation of output shaft 143 causes press drive gear 134 to rotate. A plurality of teeth that mate with the teeth of reduction gears 135a, 135b and 135c are disposed upon drive gear 134.

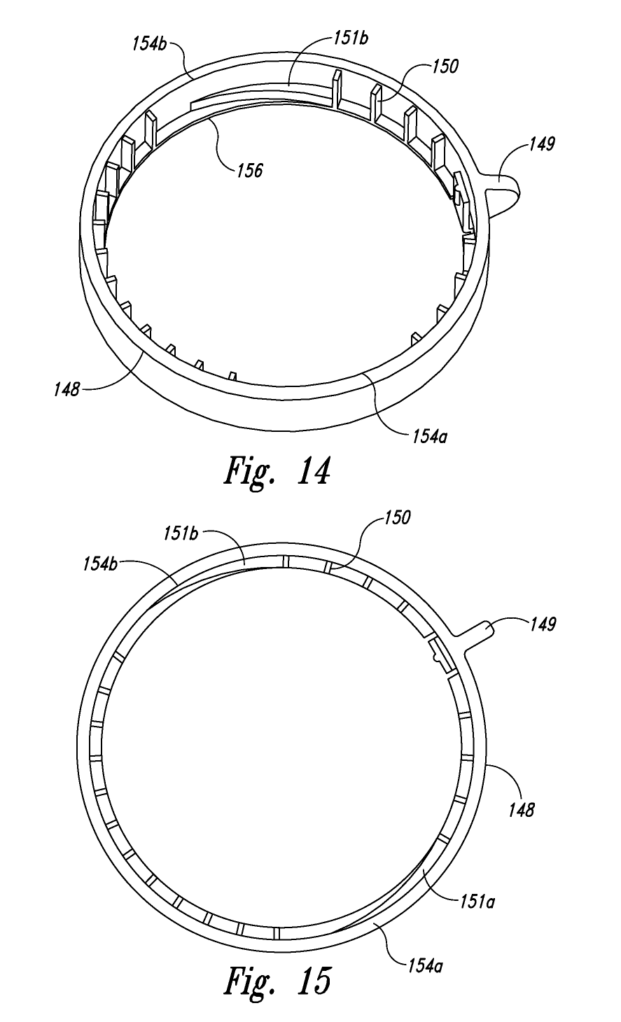

The operating position of gearbox assembly 131 is controlled by a circular rotatable collar 148 (FIG. 1) that encircles the lower portion of housing 30. An outwardly protruding collar key 149 provides means for shifting the position of rotatable collar 148 between operating position 1 (shown at 160a in FIG. 1) and operating position 2 (shown at 160b in FIG. 1). Rotatable collar 148 is held in position by an outwardly protruding annular ridge 34 on the lower portion of housing 30 and by an outwardly protruding annular ridge 44 (shown in FIG. 6) on the lower portion of housing floor 40. A plurality of vertical ribs 150 (shown in FIG. 14) disposed on a portion of the interior surface of rotatable collar 148 also provide means for holding rotatable collar 148 in place relative to housing 30.

Gearbox assembly 131 is laterally slidable within housing 30, but is stationarily positioned from the perspective of back-to-front movement. An upwardly protruding ridge 130 (shown in FIG. 6) disposed on the top surface of housing floor 40 and a gearbox receiving slot 158 (shown in FIG. 10) provide means for restricting back-to-front movement of gearbox assembly 131. Restriction of back-to-front movement is achieved by aligning the front portion of the gearbox 152 (shown in FIG. 11) with upwardly protruding ridge 130 (FIG. 6) and by aligning the back portion of the gearbox 153 (FIG. 11) with the gearbox receiving slot 158 (shown in FIG. 10). The fit between front portion of the gearbox 152 and upwardly protruding ridge 130 and between back portion of the gearbox 153 and gearbox receiving slot 158 is sufficiently loose to accommodate the degree of side-to-side movement needed to shift gearbox assembly 131 between operating position 11 and operating position 2.

As shown in FIG. 114 and FIG. 15, two portions of the interior surface of rotatable collar 148 do not include ribs and are provided as shifting recesses 154a and 154b. A shifting ramp 151a and a shifting ramp 151b are respectively disposed within shifting recesses 154a and 154b. A gearbox key 155a and a gearbox key 155b (FIG. 11) are respectively configured to glide along shifting ramp 151a and shifting ramp 151b when the position of rotatable collar 148 is shifted between operating position 1 (shown in respect of a general view of the apparatus at 160a in FIG. 1) and operating position 2 (shown in respect of a general view of the apparatus at 160b in FIG. 1). A gearbox key slot 157a and a gearbox key slot 157b (shown in FIG. 10) provide means for holding the gearbox stably in place in both of its operating positions. In the case of the embodiment of the automatic batter press of the present invention shown in FIG. 10, gearbox key slots 157a and 157b are configured as notches in the lower edge of housing 30 and are sized to receive gearbox keys 155a and 155b.

When rotatable collar 148 is shifted from operating position 2 to operating position 1, gearbox key 155a glides down shifting ramp 151a and gearbox key 155b glides up shifting ramp 15 lb. In this process, gearbox key 155b slides out of gearbox key slot 157b and gearbox key 155a slides into gearbox key slot 157a. When rotatable collar 148 is shifted from operating position 1 to operating position 2, gearbox key 155b glides down shifting ramp 151b, gearbox key 155a glides up shifting ramp 151a, gearbox key 155b slides into gearbox key slot 157b and gearbox key 155a slides out of gearbox key slot 157a.

As shown in FIG. 6, housing floor 40 includes a protrusion 137 that provides means for positioning drive gear 134 within housing 30 and relative to gearbox assembly 131. Protrusion 137 mates with a bore in the lower portion of drive gear 134 (shown in FIG. 8). Motor output shaft 143 protrudes through a hole 145 (FIG. 10) in a motor mounting plate 1.40 and fits into slot 144 (FIG. 8) in the upper portion of drive gear 134. Motor 142 is attached to motor mounting plate 140 (FIG. 10). Motor mounting plate 140 is attached to a motor mounting structure 141 (FIG. 6) disposed on housing floor 40. Together with protrusion 137, motor mounting structure 140 provides means for securely positioning drive gear 134 in housing 30. In the preferred embodiment of the apparatus of the present invention, the front portion 32 and back portion 31 of housing 30 are affixed to each other by means of the front housing connectors 38 and the back housing connectors 37 shown in FIG. 10. This connection ensures that back of the battery compartment 87 and gearbox receiving slot 158 are also held securely in place such that drive shaft assembly 120 and gearbox assembly 131 are properly positioned within the interior compartment of housing 30.

When gearbox assembly 131 is shifted into operating position 1 (shown at 131b in FIG. 12), the teeth of drive gear 134 engage the teeth of reduction gear 135b, which in turn engage the teeth of reduction gear 135c, which engage the vertical ribs of gear shaft 121. When activation button 80 is depressed, the rotation of motor output shaft 143 causes drive gear 134 to spin in a clockwise direction. The rotation of drive gear 134 causes reduction gear 135b to spin in a clockwise direction about pin 138b by which it is held in place in gearbox assembly 131. The rotation of reduction gear 135b in turn causes reduction gear 135c to spin in a clockwise direction about pin 138c by which it is held in place in gearbox assembly 131. The rotation of reduction gear 135c causes gear shaft 121 to rotate in a clockwise manner and thereby to produce downward movement of piston 90 for dispensing of barrel contents.

When gearbox assembly 131 is shifted into operating position 2 (shown at 131 c in FIG. 13), the teeth of drive gear 134 engage the teeth of reduction gear 135a, which in turn engage the vertical ribs of gear shaft 121. When activation button 80 is depressed, the rotation of motor output shaft 143 causes drive gear 134 to spin in a clockwise direction. The rotation of drive gear 134 causes reduction gear 135a to spin in a counterclockwise direction about pin 138a by which it is held in place in gearbox assembly 131. The counterclockwise rotation of reduction gear 135a causes gear shaft 121 to rotate in a counterclockwise manner and thereby to produce upward movement of the piston 90 for refilling barrel contents.

To operate the automatic batter press of the present invention, the user aligns operating collar key 149 with a label on the exterior surface of front portion 32 of housing 30 indicating the desired operating position of gearbox assembly 131. After gearbox assembly 131 is in the desired operating position, the user depresses activation button 80 to activate the apparatus. To prepare the apparatus for receiving batter, operating collar 148 is turned to operating position 2 (retract, which is shown at 160b in FIG. 1) and activation button 80 is depressed. This causes piston 90 to move upward within barrel 50.

The user continues to depress activation button 80 until piston 90 has travelled a sufficient distance that the capacity of the portion of barrel 50 extending between piston 90 and the lower end of barrel 50 is sufficient to accommodate the volume of batter that the user wishes to dispense (which may be less than the maximum volume of batter barrel 50 can contain). After the user fills barrel 50 with the desired quantity of batter, barrel cap 60 is screwed onto the lower portion of barrel 50, rotatable collar 148 is shifted to operating position 1 (dispense, shown at 160a in FIG. 1), automatic batter press 20 is turned over, bottom edge 66 of piping spacer 62 is positioned on the baking surface, activation button 80 is depressed and piston 90 advances within barrel 50, which causes batter to be extruded through lower aperture 72 of dispensing nozzle 70. After batter for one pastry is dispensed, the edge of piping spacer 62 is repositioned adjacent to the edge of the quantity of batter previously dispensed, activation button 80 is depressed to dispense another quantity of batter and this process is repeated until all batter has been dispensed.

The speed at which piston rod 102 advances within barrel 50 has been calibrated to be sufficiently slow that timing variations inherent in a user's operation of a momentary activation button are mitigated and the user can easily dispense substantially equal quantities of batter. Specifically, when the user depresses activation button 80, the configuration of reduction gears 135b and 135c slows batter flow velocity to a point where simple counting techniques can be employed to effectively meter the length of time the activation button is depressed and thereby the quantity of batter that is dispensed. The duration of the period for which activation button 80 should be depressed will depend on the desired quantity of batter dispensed, which will be proportional to the desired size of the pastry being produced.

To clean the automatic batter press of the present invention, barrel cap 60 is unscrewed from barrel 50 and barrel 50 is unscrewed from housing 30. After all parts requiring cleaning been cleaned, barrel 50, Barrel cap 60, and nozzle cap 73 are reassembled and screwed onto housing 30. In preparation for storage, piston 90 is fully extended toward barrel cap 60 such that the entirety of piston rod 102 is housed internally within the apparatus.

Through incorporation of the various features described above, the apparatus of the automatic batter press of the present invention represents a device that is compact, easy to use, easy to clean, and convenient to store. Additionally, the features of this invention minimize batter spillage and waste, enable the user to easily produce uniformly sized and shaped pastries, and allow the user to dispense batter on a baking surface in a consistent and efficient manner, and to adjust the size of pastry produced as desired.

While the invention has been shown only in its preferred embodiment, it should be apparent to those skilled in the art that various modifications to the embodiment presented may be made without departing from the scope of the invention, which is defined by the appended claims.

What is claimed is:

1. An apparatus for dispensing a flowable food substance, said apparatus comprising:
a. a housing that contains a motor, where said motor is in communication with a power source,
b. means for activating the power and energizing said motor,
c. a hollow barrel removably connected to said housing and adapted to receive a food substance,
d. a piston configured for slidable advancement within said barrel where said piston is coupled with a rod that includes threads disposed over a portion of its length,
e. means on said piston and means on said barrel that cooperate to prevent rotation of said piston within said barrel,
f. a gearbox located in said housing that is in communication with said motor and that provides means for shifting the direction of travel of said piston within said barrel,
g. a piston rod drive mechanism located in said housing that is in communication with said gearbox and that engages said threaded portion of said rod to create linear movement of said piston within said barrel when said motor is energized,
h. a cap removably connected to said barrel,
i. a dispensing member attached to said cap through which batter is dispensed from said barrel when said piston is advanced within said barrel.

2. The apparatus of claim 1 wherein said gearbox includes a gear assembly configured to engage with said piston rod drive mechanism such that said piston rod is actuated to advance within said barrel, and wherein said gearbox also contains a separate gear assembly configured to engage with said piston rod drive mechanism such that said piston rod is actuated to retract within said barrel.

3. The apparatus of claim 1 wherein said gearbox includes means for engaging said piston rod drive mechanism in both clockwise and counterclockwise directions.

4. The apparatus of claim 3 wherein said housing includes means for allowing lateral movement of said gearbox while preventing movement in other directions.

5. The apparatus of claim 4 wherein shifting ramps disposed in opposing positions upon the interior surface of a rotatable collar that attaches to said housing are in contact with said gearbox.

6. The apparatus of claim 5 wherein said dispensing member includes a hollow interior passage wherein the diameter of the upper aperture of said hollow interior passage is smaller than the diameter of the lower aperture of said hollow interior passage.

7. The apparatus of claim 6 wherein said cap includes a piping spacer that provides means for situating said dispensing member in a preferred position relative to the surface on which batter is dispensed.

8. The apparatus of claim 7 wherein said piping spacer consists of a protruding annular flange.

9. An apparatus for dispensing a flowable food substance, said apparatus comprising:
a. a housing that contains a motor, where said motor is in communication with a power source,
b. means for activating the power and energizing said motor,
c. a hollow barrel removably connected to said housing and adapted to receive a food substance,
d. a piston configured for slidable advancement within said barrel where said piston is coupled with a rod that includes threads disposed over a portion of its length,
e. means on said piston and means on said barrel that cooperate to prevent rotation of said piston within said barrel,
f. a drive assembly located in said housing that is in communication with said motor and that engages said threaded portion of said rod to create linear movement of said piston when said motor is energized,
g. a cap removably connected to said barrel,
h. a dispensing member disposed on said cap that includes a hollow interior passage wherein the diameter of the upper aperture of said hollow interior passage is smaller than the diameter of the lower aperture of said hollow interior passage.

10. The apparatus of claim 9 wherein said drive assembly includes a gear assembly configured to advance said piston rod within said barrel, and wherein said drive assembly also contains a separate gear assembly configured to retract said piston rod within said barrel.

11. The apparatus of claim 9 wherein said dispensing member includes a cover configured with a removable indented tip that fits inside said hollow interior passage.

12. The apparatus of claim 9 wherein said cap includes a piping spacer that provides means for situating the dispensing member in a preferred position relative to the surface on which batter is dispensed.

13. The apparatus of claim 9 wherein said cap attaches to a stand that provides means for storing the apparatus in an upright position.

14. An apparatus for dispensing a flowable food substance, said apparatus comprising:
a. a housing that contains a motor, where said motor is in communication with a power source,
b. means for activating the power and energizing said motor,
c. a hollow barrel removably connected to said housing and adapted to receive a food substance,
d. a piston configured for slidable advancement within said barrel where said piston is coupled with a rod that includes threads disposed over a portion of its length,
e. means on said piston and means on said barrel that cooperate to prevent rotation of said piston within said barrel,
f. a gearbox located in said housing that is in communication with said motor and that provides means for shifting the direction of travel of said piston,
g. a piston rod drive mechanism located in said housing that is in communication with said gearbox and that engages said threaded portion of said rod to create linear movement of said piston within said barrel when said motor is energized,
h. a cap removably connected to said barrel,
i. a dispensing member attached to said cap through which batter is dispensed from said barrel when said piston is advanced within said barrel.
j. a piping spacer attached to said cap that provides means for situating the dispensing member in a preferred position as batter is dispensed.

15. The apparatus of claim 14 wherein the piping spacer consists of a protruding annular flange.

16. The apparatus of claim 14 wherein said gearbox includes means for engaging said piston rod drive mechanism in a clockwise direction in one operating position and in a counterclockwise position in the other operating position.

17. The apparatus of claim 14 wherein said gearbox includes a gear assembly configured to engage with said piston rod drive mechanism such that said piston rod is actuated to advance within said barrel, and wherein said gearbox also contains a separate gear assembly configured to engage with said piston rod drive mechanism such that said piston rod is actuated to retract within said barrel.

18. The apparatus of claim 15 wherein said dispensing member includes a hollow interior passage wherein the diameter of the upper aperture of said hollow interior passage is smaller than the diameter of the lower aperture of said hollow interior passage.

19. The apparatus of claim 17 wherein said housing includes means for allowing lateral movement of said gearbox while preventing movement in other directions.

20. The apparatus of claim 19 wherein shifting ramps disposed in opposing positions upon the interior surface of a rotatable collar that attaches to said housing are in contact with keys protruding from each side of said gearbox.
